(19) United States
(12) Patent Application Publication
(10) Pub. No.: US 2003/0034898 A1
(43) Pub. Date: Feb. 20, 2003

(54) Thermostat and remote control system and method

(76) Inventors: Charles G. Shamoon, Raleigh, NC (US); Deborah H. Shamoon, Raleigh, NC (US); Brian Spinks, Wendell, NC (US); Dale E. Dorsett, Raleigh, NC (US)

Correspondence Address: Richard C. Litman, LITMAN LAW OFFICES, LTD., P.O. Box 15035, Arlington, VA, 22215, US

(21) Appl. No.: 09/987,035

(22) Filed: Nov. 13, 2001

Related U.S. Application Data
(63) Continuation-in-part of application No. 09/931,985, filed on Aug. 20, 2001.

(51) Int. Cl. G05B 19/02

(52) U.S. Cl. 340/825.72; 340/825.24

(57) ABSTRACT

A thermostat and remote control apparatus, that is made up of a housing, an interface, a plurality of icons on the interface, corresponding to controls for items, a display screen, indicating the current temperature setting, time and date, a recessed program and enter button for entering temperature settings to a thermostat, a clear button for deleting any entered information, a cradle that is used to recharge the apparatus, a universal serial bus port (USB) connecting a computerized device to the apparatus, an RS-232 port to standardize a transmission of serial data between any devices and the apparatus, and a microcontroller for processing information and data. The apparatus utilizes infrared and radio frequency technology for transmitting and receiving information from various items. A controlled apparatus with a microprocessor (e.g., a child monitor) is also disclosed.

### CROSS-REFERENCE TO RELATED APPLICATION

This application is a continuation-in-part of U.S. Utility patent application Ser. No. 09/931,985.

### BACKGROUND OF THE INVENTION

1. Field of the Invention

The present invention relates to an intelligent thermostat controller and hand held remote controller apparatus.

2. Description of the Related Art

Most modern families use several remote control devices to operate and utilize a wide variety of electronic equipment in their respective households. Use of a remote control is commonplace for operating televisions, stereos, garage door openers and video cassette recorders. Remote control systems are also used at the commercial level. Furthermore, a variety of different technologies can be applied to a remote control.

The related art discloses the use of a remote control to control several pieces of equipment. U.S. Pat. No. 4,965,557 issued to Schepers et al., outlines the use of the interactive control of an entertainment electronics apparatus. The apparatus can be simplified so that an unpracticed user can easily make all of the necessary or desired adjustments wanted, even in the case of a large, seemingly complex system.

U.S. Pat. No. 5,109,222 issued to Welty, describes certain improvements in remote control systems for controlling electronically operable equipment in occupiable structures, and more specifically to remote control equipment with an essentially unlimited command format such that the system is responsive to a large number of pieces of electronic equipment having different command formats, and which system can generate encoded signals compatible with any such electrically operated equipment.

U.S. Pat. No. 5,544,036 issued to Brown, Jr. et al., describes the use of an energy management and home automation system which includes one or more controllers in each facility being managed, and one or more energy consuming devices attached to each controller. Each controller responds to digital paging signals from a central command center which establish a schedule of events effecting the operation of each device, and the controller schedules each device to be operated pursuant to the programmed schedule.

U.S. Pat. No. 5,545,857 issued to Lee et al., teaches a remote control method and apparatus for a remote controller having a touch panel as an image apparatus, and performing a remote control operation of an image apparatus, such as a television, either by inputting a character onto the touch panel or by controlling a cursor according to the contact location of a finger or a pen contacting the touch panel.

U.S. Pat. No. 5,579,496 issued to Van Steenbrugge, teaches the use of a method and apparatus for processing control instructions received from at least 2 identifiable sources via a communication connection. The method can be used in apparatuses which are coupled together by a bus. The invention also relates to an apparatus provided with a control circuit adapted to perform the method.

U.S. Pat. No. 5,621,662 issued to Humphries et al., teaches a home automation system made up of a number of sub-systems for controlling various aspects of a house, such as a security system, an HVAC system, a lighting control system and an entertainment system. The network utilizes a host computer connected through a host interface to a plurality of nodes. The network is in a free form topology and employs asynchronous communication.

U.S. Pat. No. 5,818,428 issued to Eisenbrandt et al., teaches the use of a control system with a user configurable interface, particularly suitable for use in connection with appliances. Users can configure display screens at a point of sale location or at home with a personal computer. A user interface includes both the hardware and the software via which a user interacts with a control system and includes visual indicators, switches and display systems.

U.S. Pat. No. 5,924,486 issued to Ehlers et al., teaches the use of a residential or commercial environmental condition control system and, more specifically, to a system that controls internal environmental conditions to optimize comfort and minimize energy consumption cost, based on user defined parameters.

U.S. Pat. No. 6,005,490 issued to Higashihara, teaches the use of a bidirectional remote control apparatus which can exchange a control signal between a remote control transmitter and controlled equipment in two directions.

U.S. Pat. No. 6,081,750 issued to Hoffberg et al., teaches the use of an adaptive interface for a programmable system for predicting a desired user function, based on user history, as well as machine internal status and context. The apparatus receives an input from a user and other data. A predicted input is presented for confirmation by the user and the predictive mechanism is updated based on this feedback.

U.S. Pat. No. 6,216,956 B1 issued to Ehlers et al., teaches the use of an indoor environmental condition control and energy management system with a plurality of inputs. A user input receives user input parameters including a desired indoor environmental condition range for at least one energy unit price point. An indoor environmental condition input receives a sensed indoor environmental condition. An energy price input receives a schedule of projected energy unit prices per time periods.

Each of the described patents have a useful application regarding remote controls and remote control systems. None, however, can completely bypass the use of a personal computer and constantly update the readings from the components of a remote control system. No system also includes temperature setting controls with more common appliance and electronic device controls as well.

None of the above inventions and patents, taken either singularly or in combination, is seen to describe the instant invention as claimed. Thus a thermostat and remote control apparatus and method solving the aforementioned problems is desired.

### SUMMARY OF THE INVENTION

The invention is a thermostat and remote control apparatus that is made up of a housing, an interface disposed in the housing, a plurality of icons on the interface, which correspond to a set of controls for items that can be monitored and controlled by the apparatus, a display screen, which indicates the current temperature setting, time and date, a recessed program and enter button that allows a user to enter temperature settings to a thermostat, a clear button for deleting any entered information, an electric cradle that is used to recharge the apparatus, serial and parallel ports, such as universal serial bus port (USB), RS-232 port and other protocols, that may be used to connect to computerized devices and for standard transmission of serial data between any devices and the apparatus and a microcontroller for processing information and data. The apparatus specifically utilizes infrared and radio frequency technology.

Accordingly, it is a principal object of the invention to provide a remote control that can make changes to a thermostat.

It is another object of the invention to provide a remote control that can be run independently of a personal computer.

It is a further object of the invention to provide a remote control that can constantly monitor, control, and update information.

It is another object of the invention to provide total PC program and function capability.

It is another object of the invention to provide total two-way communication capability.

It is another object of the invention to provide an intelligent thermostat which can control, monitor and communicate to a HVAC system and a thermostat and remote controller apparatus.

It is another object of the invention to provide a charger cradle capable of interfacing with the thermostat and remote controller apparatus providing charging power and additional memory media system that allows uploading and downloading of files and programs, and provides telephone communication.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a thermostat and remote control apparatus according to the present invention.

FIG. 2 is a front perspective view of a remote control apparatus according to the present invention.

FIG. 3 is a perspective view of a remote control apparatus and charger according to the present invention.

FIG. 4 is a perspective view of a remote control apparatus and its components according to the present invention.

FIG. 5 is a block diagram of a remote control apparatus and its entertainment center components according to the present invention.

FIG. 6 is a block diagram of a remote control apparatus and its thermostat and X-10 components according to the present invention.

FIG. 7 is a block diagram of a remote control apparatus being used on the Internet.

FIG. 8 is an elevational view of a remote control apparatus in the form of a watch.

FIG. 9 is a block diagram of the remote control apparatus of the embodiment shown in FIG. 8.

Similar reference characters denote corresponding features consistently throughout the attached drawings.

### DETAILED DESCRIPTION OF THE PREFERRED EMBODIMENTS

A general discussion of the invention and its capabilities is in order. The handheld controller of this invention performs as a handheld personal computer (PC). Thus, a principal thrust of the invention is to eliminate the need for a PC for the many and myriad applications discussed hereinbelow. The remote apparatus therefore has multiple control and monitoring capabilities which are disclosed herein. The prepackaged software will operate with a standard operating system provided in the remote control apparatus just as with any PC.

The wall thermostat controller of the invention uses the same operating system as the handheld controller, has similar hardware, and performs pretty much the same. However, the thermostat controller embodiment will not utilize all the programs of the handheld unit, and is used mainly for the control and monitoring of an HVAC system, security, etc.

There is yet a miniaturized version of the remote control apparatus in the form of a child's wrist watch, for example. Both hardware and software will be limited in this embodiment, all as explained on detail hereinbelow.

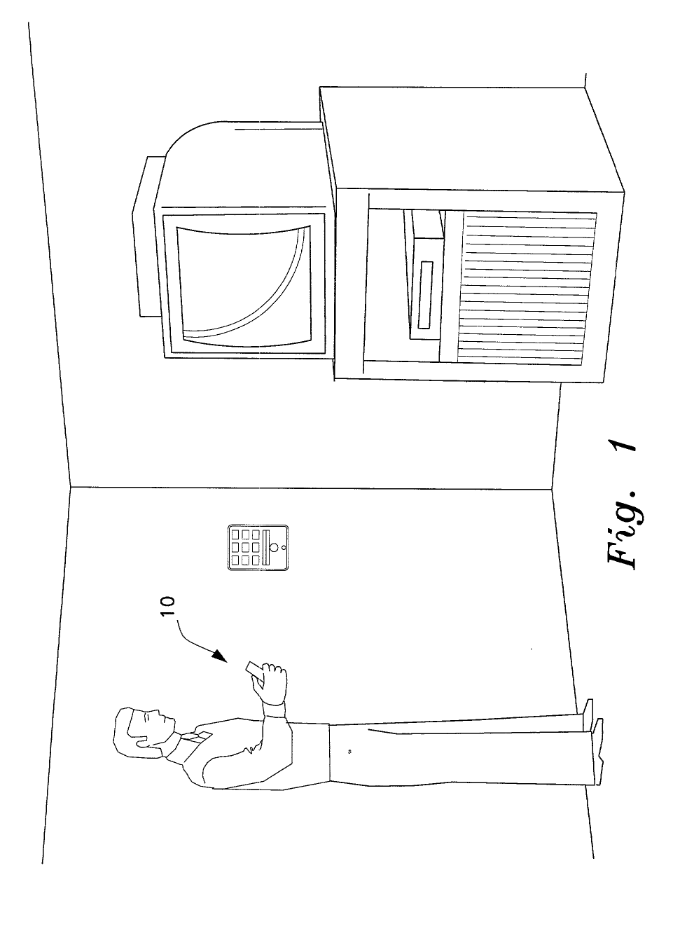

The present invention relates to an intelligent thermostat controller and hand held remote controller apparatus 10. The thermostat and remote control apparatus 10 consolidates all remote controls into a single remote control, as well as combines the capability to monitor and control a user's thermostat and HVAC. The thermostat and remote control apparatus 10 is illustrated in FIG. 1.

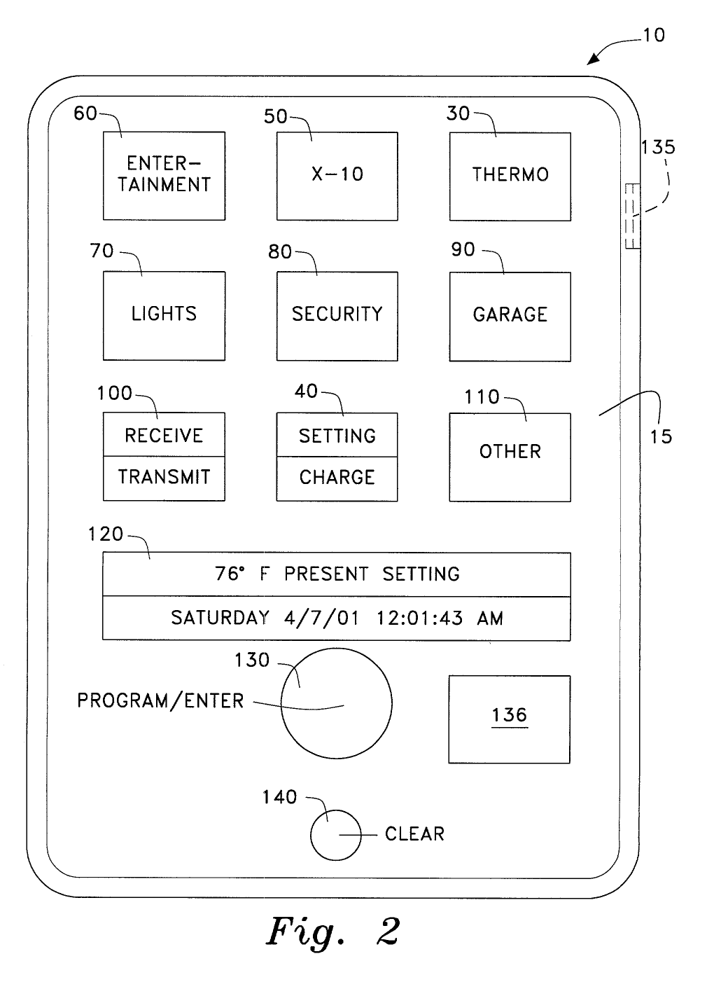

Turning now to FIG. 2, the thermostat and remote control apparatus 10 has a housing and interface 15. The housing and interface 15 displays a plurality of icons that can be chosen, which correspond to a set of controls for each item that can be controlled by the thermostat and remote control apparatus 10. For example, an “Entertainment” icon 60 is shown and can be selected. Once selected, by depressing the “Entertainment” icon 60, the entire face of the thermostat and remote control apparatus 10 changes to a variety of control icons that pertain to the selected icon.

In the case of the selected “Entertainment” icon 60, the main menu would then display various components of the user's entertainment center, such as a CD player, a television, a record player and any other components of the user's entertainment center. Each component from the entertainment center has its own set of settings, which are displayed on the housing and interface 15 of the thermostat and remote control apparatus 10 once selected by the user.

The thermostat facing is the same as the remote control apparatus 10, only without the entertainment icon 60. With this icon, automatic or manual adjustments can be made.

An “on/off” power button 135 is provided on the casing, and is recessed to prevent accidental depression.

The settings can also include a display touch screen as well as “Volume” settings, “Channel” settings and other settings. As shown in FIG. 2, other icons include X-10 system settings 50, a thermostat setting 30, light settings 70, a security system setting 80 and a garage setting 90. An icon for indicating when a signal is transmitted and/or received 100 is provided and will light up the appropriate icon half when being completed. An “Other” 110 icon can also be used for adding additional and lesser used components to the thermostat and remote control apparatus 10. The “Setting” icon 40, also has a lower half “Charge” icon, which can be illuminated to indicate that the apparatus 10 is being charged up.

A display screen 120 is provided to display icons for each function, and programming and messaging. Thermostat setting and time and date are continually displayed on the screen, unless disabled. “Program entry” icon button 130 and “clear” icon button 140 may also be present as separate buttons, as shown in FIG. 2, or they may be part of the display screen 120. A light sensor 136 is provided to sense levels of ambient light to adjust contrast and background lighting when unit is first turned on. Additional adjustments may be made via special icon(s) (not shown).

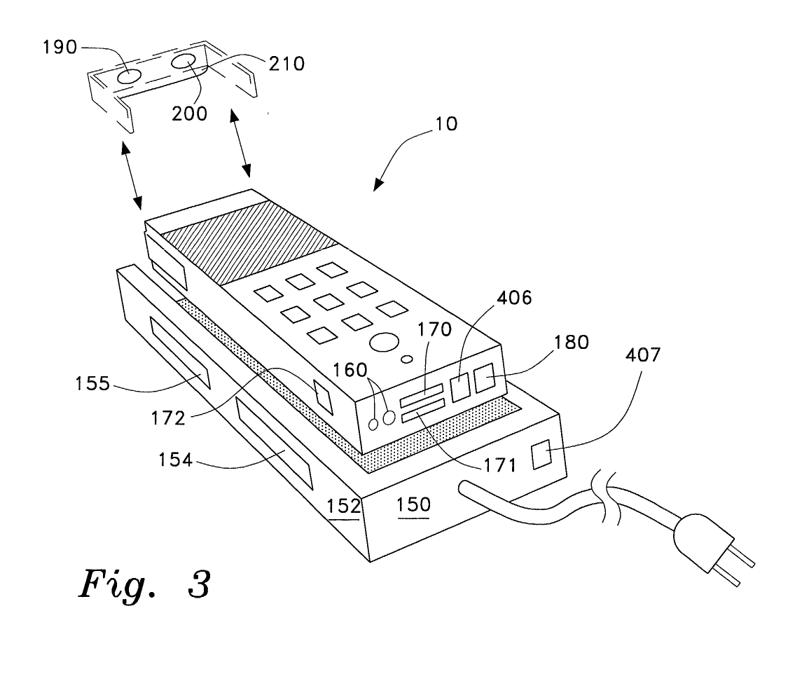

FIG. 3 illustrates a cradle 150 that is used to charge up the apparatus 10. The cradle 150 has two contact points 160 that are in contact with the thermostat and remote control apparatus 10 while the thermostat and remote control apparatus 10 is charging. There is also a universal serial bus (USB) port 170 that can be connected to another computer and a recommended standard (RS-232) port 180 is also used. to standardize the transmission of serial data between devices.

Cradle 150 may also connect to serial or parallel port 171 for video, media memory unit and other media. The serial/parallel port 171 may be utilized for any existing port or jack for present or future applications. Telephone jack 407 on cradle 150 provides a connection to a telephone wall jack (not shown) for telephone communications. A second telephone jack 405 on the apparatus 10 is connected to the cradle jack 407 internally of the cradle (not shown). Parallel bus port 172 may be used to provide a full control address data bus interface connector for external module interface.

The thermostat and remote control apparatus 10 can be charged both with the cradle 150 or from a charger unit using a standard electrical outlet (not shown). A barcode scanner or OCR document scanner can also be connected to the thermostat and remote control apparatus 10 via one of the serial/parallel ports 170, 171 or 180.

The cradle 150 allows a user to utilize the thermostat and remote control apparatus 10 while it is being charged. This can occur since the infrared transmitter 190 and receiver 200 are openly exposed through the open side of the cradle 150, and allow for infrared interactions. An antenna 210 is also openly exposed as well to allow for radio frequency (RF) reception and transmission.

The cradle 150 contains a charging power supply and capability to read and write data into a memory media 152 stored in the cradle 150. Read and write communication is transferred through connection(s) provided by serial/parallel ports 170, 171, or 180 to the cradle 150 while the thermostat and remote control apparatus 10 is connected.

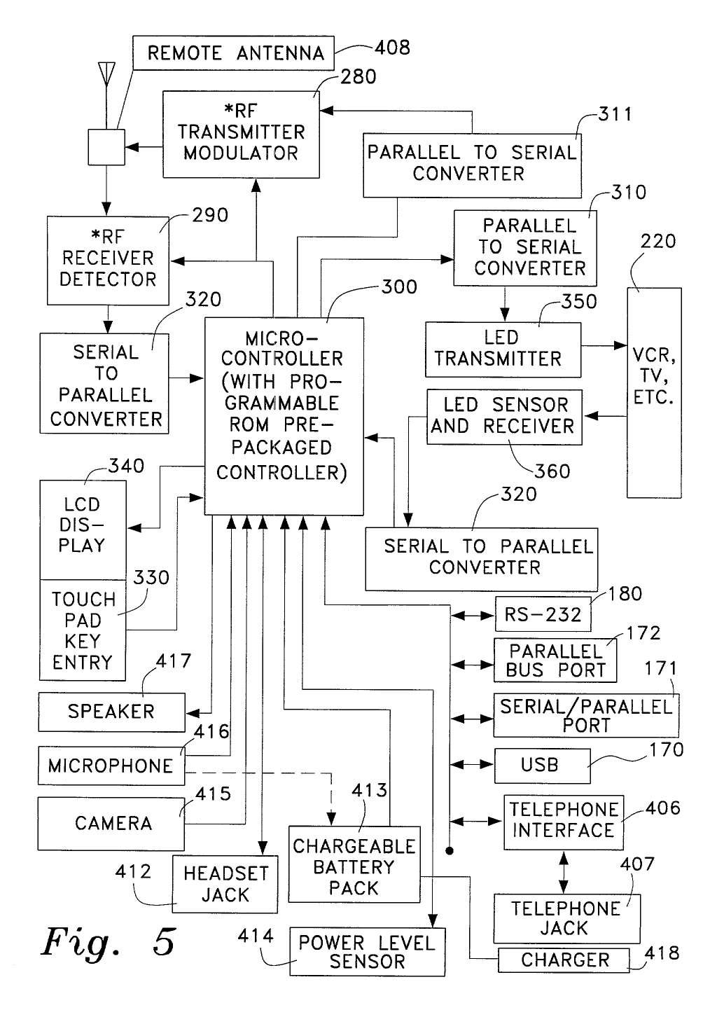

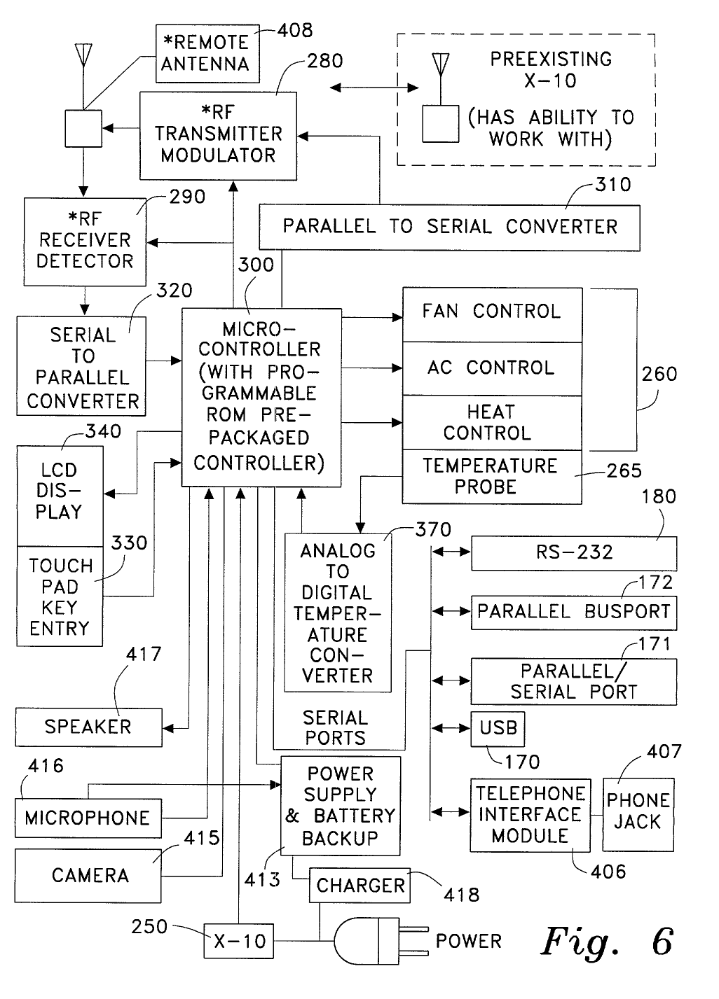

One implementation of auxiliary memory may include read-only memory (ROM), a read and write floppy disk drive 154, memory stick port (not shown), a read and write CD drive 155 and random access memory (RAM). This will require a microcontroller 300 (see FIGS. 5 and 6) for the purpose of interfacing the thermostat and remote control apparatus 10 with the memory media 152 in the cradle 150. The thermostat and remote control apparatus 10 may store data in the memory media 152 or upload data from the auxiliary memory. The telephone hookup 407 to the cradle 150 could also be implemented, and the microcontroller 300 could control the charger 418 (see FIGS. 5 and 6 as well).

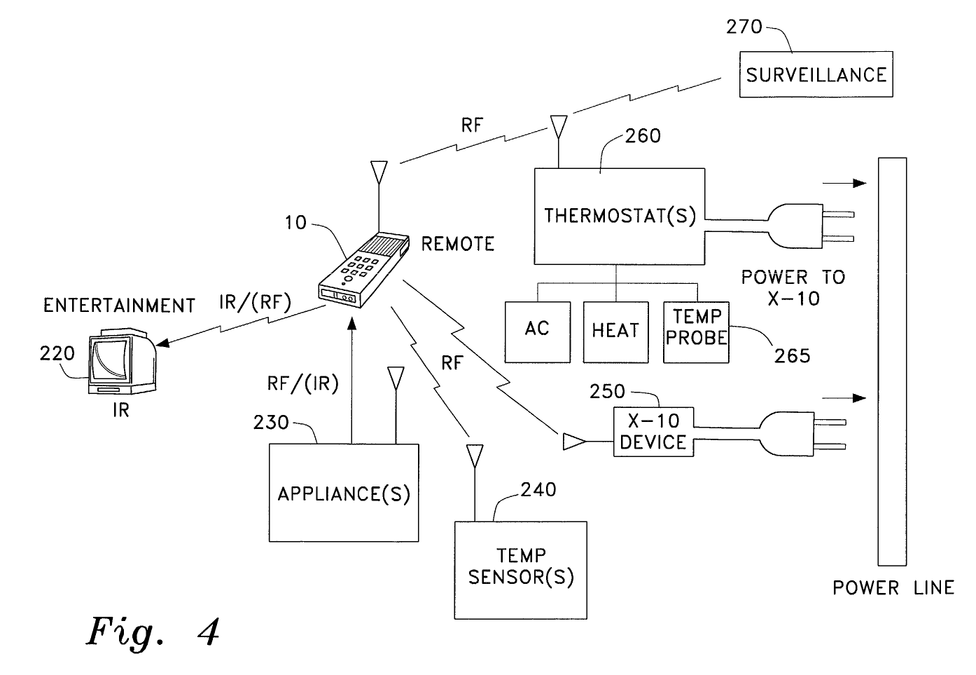

FIG. 4 depicts the thermostat and remote control apparatus 10 and its various components. There is a transmitting means for transmitting a signal to an entertainment center 220 and household appliance(s) 230, which utilize infrared technology. The entertainment center 220 and household appliances 230 must be provided with an infrared signal transmitter (not shown) and receiver (not shown) to correspond and communicate with the infrared transmitter 190 and receiver 200 (see FIG. 3) of the thermostat and remote control apparatus 10.

The thermostat and remote control apparatus 10 also utilizes radio frequency technology. A transmitting means for transmitting a signal to a temperature sensor 240, an X-10 device 250, a thermostat 260, surveillance equipment 270 and entertainment center 220, are provided, which utilize radio frequency technology (RF).

The temperature sensor 240, the appliance 230, X-10 device 250, thermostat 260, entertainment center 220 and surveillance equipment 270 must be provided with an RF transmitter and receiver (not shown) to correspond and communicate with the RF transmitter 280 (FIG. 6) and receiver 290 (FIG. 6) of the thermostat and remote control apparatus 10. The thermostat 260 and temperature probe 265 are the controlling devices for a user's heating and air conditioning equipment, which are typically powered by electricity and natural gas. A temperature sensor 240 may be used to sense temperature in a remote location.

The thermostat and remote control apparatus 10 can communicate, via radio frequency, to additional thermostat and remote control apparatuses 10. The thermostat and remote control apparatus 10 also has the capability to communicate through the frequency spectrum via cell telephone, satellite communication, the GPS system, weather radio, radio time update and local RF intercommunication radio frequencies.

There is also two-way communication between the thermostat and remote control apparatuses 10 and other control devices, via RF, infrared and ultrasonic technology. The thermostat and remote control apparatus 10 can provide the status of the controlled and monitored device, as well as the temperature, the time, and the on/off activation switches for the HVAC.

FIG. 5 depicts an overview of the infrared technology used by the thermostat and remote control apparatus 10. A powerful microcontroller 300 is at the heart of the use of the infrared technology. The microcontroller 300 is also provided with programmable memory (such as RAM, PROM and flash PROM) as well as prepackaged software (not shown) that runs the hardware and other components of the thermostat and remote control apparatus 10. This software is known to those skilled in the related art.

The infrared receiver 290 receives an infrared signal and runs the signal to a serial to parallel converter 320 before sending the signal to the microcontroller 300. The infrared transmitter 280 uses a parallel to serial converter 310 before sending information from the microcontroller 300. Information is input into the microcontroller 300 from a touchpad 330 and is displayed on a liquid crystal diode (LCD) display 340 of the interface 15.

Similarly, the microcontroller 300 sends a signal to a parallel to serial converter 310 to a light emitting diode (LED) transmitter 350, which sends a signal to the entertainment center 220. The entertainment center 220 then sends a signal back to the LED receiver 360, which send a signal to a serial to parallel converter 320, which then sends a signal to the microcontroller 300. The microcontroller 300 is also directly linked to a USB port 170 and a RS-232 port 180. The microcontroller 300 may also be reprogrammed via USB port 170 or RS 232 port 180.

A speaker 417, a microphone 416, a telephone jack 407 and a camera 415 interface directly with the microcontroller 300 via appropriate interfaces. The thermostat and remote control apparatus 10 also has the capability of visual or audio surveillance of other remote units or dedicated surveillance units or devices. A chargeable battery pack 413 connects to the microcontroller 300, parallel to serial converter 310, LED transmitter 350, serial to parallel converter 320, RF receiver detector 290, parallel to serial converter 311, and RF transmitter modulator 280. There is also a headset jack 412 to interface with the microcontroller 300 as well.

Digital communication to external devices may be conveyed through a serial/parallel port such as 170 or 171, and also telephone port 407, RF antenna 408 and IR transmitter 190 and receiver 200. All of these interfaces allow communications to external key boards and monitors, surveillance apparatus, automobile controls and monitors, household controls and monitors, various controlled and monitoring devices, memory storage devices, telephones, and interfacing to multiple communication and digital media devices (shown in FIG. 4). There are also other interfaces for a headset jack 412, speaker 417, microphone 416 and camera 415 used for enhanced communication.

The camera 415 and microphone 416 can be used with a LCD display 340 for videophone and other multimedia applications. All ports are on the thermostat and remote control apparatus 10. The thermostat and remote apparatus 10 may run programs and games like those designed for a personal computer or laptop computer. It can perform control and monitoring functions. It can allow viewing on an external monitor or input from an external keyboard. The keyboard media could be like those on a common personal computer or can be uniquely designed to interface with the thermostat and remote control apparatus 10 (Plugged into keyboard). A computerized device's storage media may also be utilized by the thermostat and remote control apparatus 10.

There is, of course, software internally of apparatus 10 which provides the interface between control, communications and software functions, and the LCD display, touch screen and I/O port data. The software also allows the apparatus 10 to accept and process the various I/O stimuli received for controlling, monitoring and processing information. As desired, the software can provide the necessary interface for running popular PC programs, games and communication(s) software.

Further with reference to FIG. 4, parallel busport 172 is recessed into the body of apparatus 10; a blank is installed here if an add-on module is not installed. Such add-on modules can add such features as, without limitation, expanded memory, program memory (e.g., preinstalled specific programs or reserved for the storage of programs), co-processor, other storage media, etc.

A chargeable battery pack 413 may be charged from an external circuit such as cradle 150 or separate charger 418. The chargeable battery pack 413 may be trickle charged using a v-bus of a USB port 170, if so dedicated, connected to an external port or a built in microphone 416 when in idle mode. It could charge off of rectified power generated by background noise. When not in idle mode, the built in microphone 416 would perform as a normal microphone. The thermostat and remote control apparatus 10 has voice activation and voice recognition capabilities via voice activation software, which is well-known to those schooled in the related art.

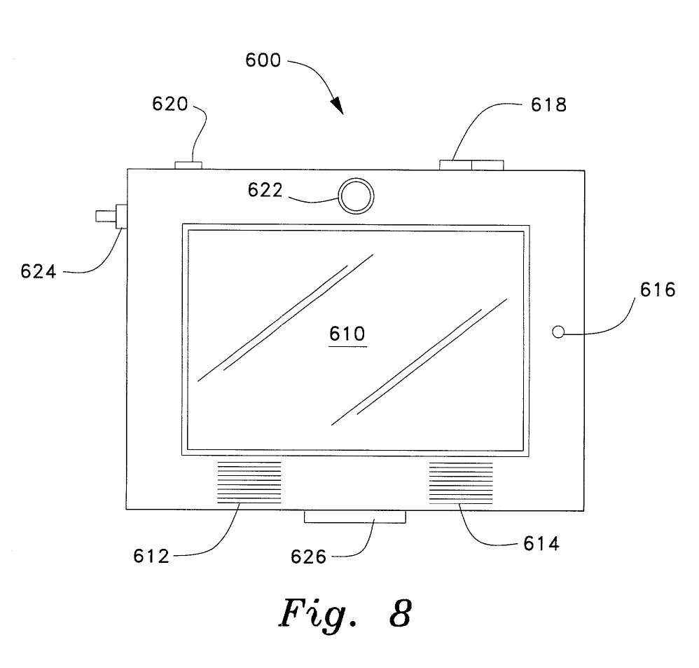

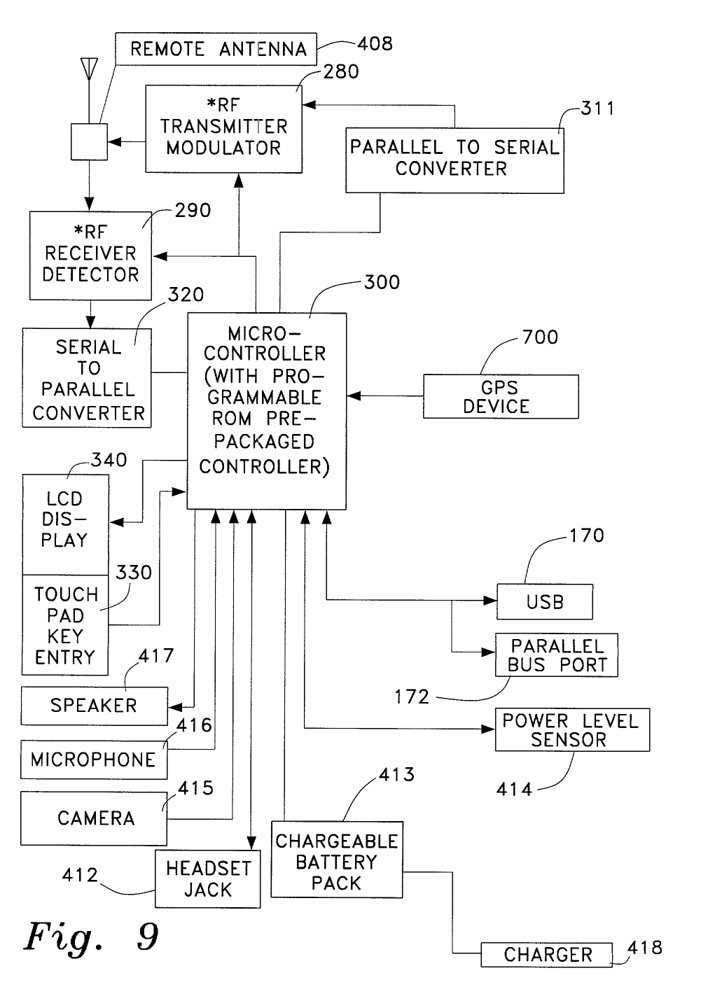

There is a miniature version (not shown) of the thermostat and remote control apparatus 10 that is designed for children and that is made up of some of the basic components with equal or slightly less control capability. There are also some programming differences, with the miniature version having fewer control functions and having a focus on a polling wrist band for locating and tracking children as part of a GPS system, time and date information, an alarm, and games. A stealth mode can be programmed not to trigger an alarm when the chosen GPS system acquires a location of a particular transmitter (not shown). Such a system is discussed in detail hereinbelow, with reference to FIGS. 8 and 9.

The use of RF technology is similarly used and outlined in FIG. 6. An RF receiver 290 receives a RF signal and sends a signal to a serial to parallel converter 320, which is then sent to a microcontroller 300. The microcontroller 300 then sends a signal to the LCD display 340. A user then enters desired information from a touchpad 330, which is sent to the microcontroller 300, which is sent to a parallel to serial converter 310 and eventually to a RF transmitter 280.

A temperature probe 265 also sends a signal to an analog to digital temperature converter 370, which sends a signal to the microcontroller 300. The microcontroller 300 then sends a signal to the fan control, air conditioning control and heat control of the thermostat 260. An X-10 250 adapter is also in direct contact with the microcontroller 300, which can communicate and be powered by a standard wall outlet. The microcontroller 300 will lay dormant when not in use and can be reactivated by pressing the program/enter key 130 (FIG. 2).

The additional remote antenna connector 408 may be used to communicate with remote devices such as a microwave dish or other RF media. Remote antennae connector 408 interfaces with the RF receiver detector 290 and the RF transmitter modulator 280. A speaker 417, a microphone 416, a camera 415 and external jacks may also be connected to the microcontroller 300 via applicable interfaces. Charger 418 and chargeable battery pack 413 are interconnected between the microcontroller 300, receiver detector 290, transmitter modulator 280, LCD display 340, serial to parallel converter 320 and parallel to serial converter 310. A telephone jack 407 is connected to the telephone interface module 406, which interfaces the microcontroller 300.

The thermostat and remote control apparatus 10 does not need to utilize a personal computer because of the powerful microcontroller 300 incorporated with the thermostat and remote control apparatus 10. Two-way communication exists between the thermostat and remote control apparatus 10 and the thermostat 260. Date, time and thermostat settings are updated from the thermostat 260 to the thermostat and remote control apparatus 10 periodically

The thermostat 260 has “Transmit” and “Receive” indicators that show the communication states of the thermostat and remote control apparatus 10. There is a built-in clock on the thermostat and remote control apparatus 10 that is synchronized to the thermostat 260. The thermostat and remote control apparatus 10 also has “Program\Enter” button 130 that allows a user to enter and activate a setting on the touchpad 330 display such as temperature settings to the thermostat 260.

The thermostat and remote control apparatus 10 has HVAC power and diagnosis equipment that utilizes parameters such as refrigerant pressure differential and the time involved with a specific temperature change. The HVAC power and diagnosis equipment also monitors and controls the air flow control and monitoring of individual spaces and humidity.

The thermostat and remote control apparatus 10 can also be connected to a digital port for a computerized device for viewing. The thermostat and remote control apparatus 10 also has a roll-over communication capability and equipment 440 where if one form of communication is not available, other available communications devices can be utilized.

The thermostat and remote control apparatus 10 further comprises health surveillance, controlling and monitoring via suitable equipment. If a physical condition merits attention, a designated caretaker can automatically be summoned. The health surveillance equipment can also be polled to monitor a user's breathing, blood pressure, pulse or breathing and respiration rate.

The thermostat and remote control apparatus 10 can also be connected to pet surveillance, controlling and monitoring equipment.

The thermostat and remote control apparatus 10 can be tied into household security, or stand and act alone, to determine status, also to open arid close windows, lock and unlock doors, open and close drapes and vents, and turn lights on and off on a fixed or random schedule. Property control equipment can be tied into yard and greenhouse diagnosis, supervision and maintenance as well. An vehicle such as an automobile can even be started and warmed up using automobile control equipment. Furthermore, apparatus 10 can be configured to lock and unlock vehicle doors and to monitor the location of the vehicle.

The thermostat and remote control apparatus 10 is capable of logging into other computers, such as a mainframe office computer for access to various files, for reading, maintaining and updating. Also, the apparatus 10 could be configured for teleconferencing via appropriate communications, and alone or together with TV and radio audio-visual communication.

The invention can be employed effectively in contamination and decontamination control and monitoring of air and drinking water. Environmental air (e.g., in a building, shopping mall, etc.) can be monitored for contamination with pollutants such as natural gas, carbon monoxide, radon, etc. or viruses or bacteria that can be cleaned and filtered from the air. Drinking water contaminated or polluted can be chemically treated to eliminate pollutants. All can be monitored and controlled from the apparatus 10, with messages left or e-mailed to a supervisor. Further, personnel can be alerted to control any such situation. Of course, suitable monitoring and controlling hardware with appropriate communications would be present and controlled from apparatus 10.

In a similar vein, swimming pool water levels, temperature, chlorine level and presence of any contamination can be remotely monitored and controlled from apparatus 10. Sweepers and pumps can be controlled. Supervisors can be summoned for emergencies. Again, suitable hardware and appropriate communications would be present and controlled form apparatus 10.

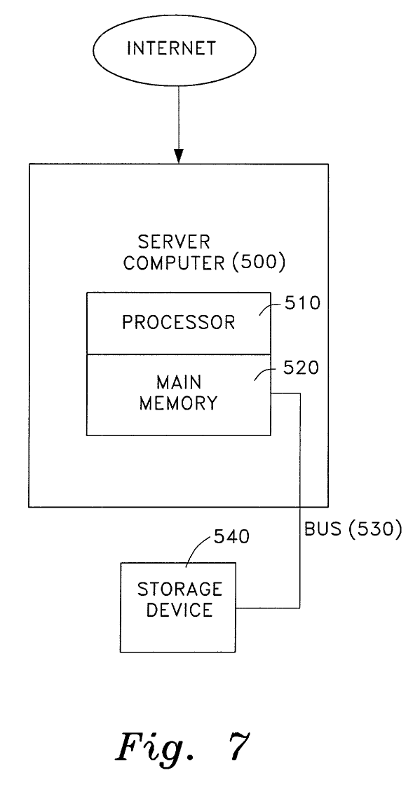

With reference now to the mainly diagrammatic view of FIG. 7, the microprocessor 300 (see FIG. 5 or 6) of apparatus 10 can be connected via bus 530 to the Internet, and a separate server computer 500 with processor 510 and main memory 520 which includes an area for executing program code under the direction of the processor 510, and a storage device 540 for storing data and program code. Also, a web-based thermostat and remote control computer code is stored in the storage device 540, and executes in main memory 520 under the direction of processor 510. Connection (not shown) to the apparatus 10 may be accomplished in any one of a variety of ways, including conventional telephone, cell and RF.

The miniaturized version of the apparatus referred to above will now be discussed in detail. The extended surveillance function(s) of the invention are numerous, but one very practical example is found in the children's watch embodiment shown in FIGS. 8 and 9. The principal function of the watch embodiment is monitoring the location of the child wearing the watch. Other important functions include an ability for 911 emergency communications, visual/audio intercommunication, and sending and receiving messages, as by e-mail, for example.

Turning now to FIG. 8, the external configuration of the remote control apparatus in the form of a child's watch 600 will be discussed. The rendition of FIG. 8 is intended to show the various functions and controls of the device, rather than illustrate what the product itself might look like. In any event, there is a central LCD display 610, speaker 612 and microphone 614 grills, a light sensor 616 for sensing ambient light and activating backlighting for LCD display 610 when light levels are below a predetermined threshhold, an on-off switch 618 (which could be recessed to prevent accidental unintended operation), a charger and external power port 620, and a camera 622. RF (for example) communication may occur via an external antenna mounted in an external antenna port 624. Alternatively, watch 600 may have a built-in antenna (not shown). A USB port is provided at 626 for the uploading and downloading of programs required for proper use of the watch.

The internal components of watch 600 are diagrammatically illustrated in FIG. 9. As can be appreciated from a comparison of this view with FIG. 6, the internals are pretty much the same, but reduced in number to suit the desired functions of watch 600.

An RF receiver 290 receives a RF signal and sends a signal to a serial to parallel converter 320, which is then sent to a microcontroller 300. The microcontroller 300 then sends a signal to the LCD display 340. A user can enter desired information from a touchpad 330, which is sent to the microcontroller 300, which is sent to a parallel to serial converter 311 and eventually to a RF transmitter 280.

The additional remote antenna connector 408 may be used to communicate with a base device 10. Remote antennae connector 408 interfaces with the RF receiver detector 290 and the RF transmitter modulator 280. A speaker 417, a microphone 416, a camera 415 and a headset jack 412 may also be connected to the microcontroller 300 via applicable interfaces. Charger 418 and chargeable battery pack 413 are interconnected between the microcontroller 300, receiver detector 290, transmitter modulator 280, LCD display 340, serial to parallel converter 320 and parallel to serial converter 311. A power level sensor 414 may be provided, with appropriate LCD readout or alarm for the user (not shown). A GPS device 700 may be internal of the unit, or attached separately. Uploading or downloading of data or software may be done through USB port 170, and plug-in modules (e.g., GPS device 700) amy attach at bus port 172.

The specific components and methodology for locating the wrist watch 600 may vary depending on current technology, reliability of components and methodology selected, and cost. One way to locate watch or apparatus 600 is to employ the GPS device 700; once activated and ready (a few minutes time, ordinarily), the device 700 will provide constant latitude/longitude coordinates (and altitude, if at least four satellites of the current GPS system are located and utilized by the GPS device 700). This data can then be transmitted from watch 600 back to the base apparatus 10; the transmission can be intermittent or continuous, of course. GPS device 700 can be built in to watch 600 or plugged in through one of the USB ports, such as 170, 171, or 180.

Another method that could be employed is the use of cell phone towers or other land based beacons and triangulation circuitry (not shown) to locate the device for the user and, if desired, also transmit the determined location back to a base unit 10. Or, based on FCC requirement on E911 mandate, a public safety answering point system can interrogate a cell phone signal (sent by unit 600—not shown) and determine the location of unit 600. Call phone and GPS technology can be employed together to locate the unit 600, particularly in multiterrain locations.

In any event, a position location device can be employed in or on the unit 600 and polled remotely, electronically, to locate where the wearer (for example, a child, a pet, an elderly person, etc.) of unit 600 is at any chosen time. Additionally, the device, if stolen, could be easily located and the police dispatched to retrieve the unit 600.

It is to be understood that the present invention is not limited to the various embodiments described above, but encompasses any and all embodiments within the scope of the following claims.

We claim:

1. A thermostat and remote control apparatus, comprising:
a housing;
an interface disposed in said housing;
a plurality of icons on the interface, which correspond to a set of controls for items that are controlled by the apparatus;
a display screen, which indicates the current temperature setting, time and date;
a recessed program and enter button that allows a user to enter temperature settings to a thermostat;
a clear button for deleting any entered information;
an electric cradle that is used to recharge the apparatus;
a (USB) port and a plurality of serial/parallel ports that are used to connect a computerized device to the apparatus;
an RS-232 port to standardize a transmission of serial data between any devices and the apparatus;
a microcontroller for processing information and data;
a serial to parallel converter and a parallel to serial converter; and
a transmitting means for transmitting a signal to and from an item that can be controlled by the apparatus.

2. The apparatus according to claim 1, further comprising an entertainment center, and wherein the item controlled by the apparatus is said entertainment center.

3. The apparatus according to claim 1, further comprising a thermostat and HVAC system, and wherein the item controlled and monitored by the apparatus is said thermostat and HVAC system.

4. The apparatus according to claim 1, further comprising household appliances, and wherein items controlled by the apparatus are said household appliances.

5. The apparatus according to claim 1, further comprising devices with an X-10 protocol, and wherein items controlled by the apparatus are said devices with an X-10 protocol.

6. The apparatus according to claim 1, further comprising a security system, and wherein the item controlled by the apparatus is said security system.

7. The apparatus according to claim 6, said security system arranged and configured to open and close windows, lock and unlock doors and windows, open and close drapes and vents, and turn lights on and off on a fixed or random schedule.

8. The apparatus according to claim 1, further comprising a global positioning locator device.

9. The apparatus according to claim 7, wherein said global positioning satellite device further comprises a programmed stealth alarm mode.

10. The apparatus according to claim 1, further comprising an OCR document scanner, and wherein the item controlled by the apparatus is said OCR document scanner.

11. The apparatus according to claim 1, wherein said electric cradle further comprises a memory media for storage.

12. The apparatus according to claim 1, wherein said electric cradle has a battery charger and chargeable battery pack.

13. The apparatus according to claim 1, wherein the apparatus is capable of communicating with a second thermostat and remote control apparatus.

14. The apparatus according to claim 13, wherein said apparatus has two-way communication capability with the second thermostat and remote control apparatuses.

15. The apparatus according to claim 1, wherein said microcontroller is connected to a speaker, a microphone, a camera and a plurality of external jacks.

16. The apparatus according to claim 1, wherein the apparatus is configured to have the capability to communicate through the frequency spectrum via a cell telephone, a satellite communication, a global positioning system, a weather radio, WWV time update and local RF intercommunication.

17. The apparatus according to claim 1, wherein a computerized device is connected to a USB port for viewing, keyboard capability and storage media utilization.

18. The apparatus according to claim 1, wherein said apparatus further comprises a built-in timer and clock.

19. The apparatus according to claim 1, wherein said apparatus further comprises voice activated and recognition software.

20. The apparatus according to claim 1, wherein said transmitting means for transmitting information to and from an item comprises an infrared transmitter and receiver.

21. The apparatus according to claim 1, wherein said transmitting means for transmitting information to and from an item comprises a radio frequency transmitter and receiver.

22. The apparatus according to claim 1, arranged and configured such that roll-over communication capability exists between said transmitting means.

23. The apparatus according to claim 1, wherein said apparatus is connected to a digital port for viewing.

24. The apparatus according to claim 1, further comprising health surveillance and monitoring equipment.

25. The apparatus according to claim 23, wherein said health surveillance and monitoring equipment is configured to poll a patient's condition.

26. The apparatus according to claim 1, further comprising pet surveillance and monitoring equipment.

27. The apparatus according to claim 1, further comprising yard and greenhouse diagnosis, surveillance, supervision and maintenance equipment.

28. The apparatus according to claim 1, further comprising vehicle engine start-up and warming equipment.

29. The apparatus according to claim 28, further comprising the configuration of said remote control apparatus to lock and unlock vehicle doors and to monitor the location of the vehicle.

30. The apparatus according to claim 1, further comprising predetermined and configured additional said remote control units that are arranged and configured to communicate, program, control, monitor and download data and/or programs to one another using one or more of IR, RF, cell, satellite or telephone communication means.

31. The apparatus according to claim 1, further comprising a touch screen and at least one I/O port, said display being an LCD display, and software means internally of the remote control apparatus for controlling, monitoring and processing information and providing an interface for running additional programs, games and communication(s) software.

32. The apparatus according to claim 31, further comprising a parallel bus port for insertion of add-on modules, said bus port being recessed into said remote control apparatus.

33. The apparatus according to claim 1, further comprising means for accessing one or more other computers from said remote control apparatus, for accessing files for reading, maintaining and updating.

34. The apparatus according to claim 1, further comprising, means for TV and/or radio audio-visual communications from said remote control unit.

35. The apparatus according to claim 1, further comprising means for teleconferencing from said remote control unit.

36. The apparatus according to claim 1, further comprising means for monitoring and controlling water and/or air contamination and decontamination.

37. The apparatus according to claim 1, further comprising means for monitoring and controlling one or more of swimming pool water levels, temperature, PH and temperature.

38. A thermostat and remote control system, comprising:
(a) at least: one server computer having a processor, an area of main memory for executing program code under the direction of the processor, a storage device for storing data and program code, and a bus connecting the processor main memory and the storage device;
(b) at least one relational database on said storage device;
(c) a data communications device connected to said bus for connecting said server computer to the Internet; and
(d) a web-based thermostat and remote control computer code stored in said storage device and executing in said main memory under the direction of said processor, the computer program including means for running and controlling the hardware of the thermostat and remote control apparatus.

39. A controlled remote control apparatus, comprising:
a housing;
an interface disposed in said housing;
a plurality of icons on the interface, which correspond to a set of controls for items that are controlled by the apparatus;
a display screen;
a clear button for deleting any entered information;
a (USB) port for the uploading and downloading of predetermined software and data;
a microcontroller for processing information and data;
a serial to parallel converter, and a parallel to serial converter; and
a transmitting means for transmitting a signal to and from an item that can control the apparatus.

40. The apparatus according to claim 39, further comprising a thermostat and remote control apparatus, which comprises:
a housing;
an interface disposed in said housing;
a plurality of icons on the interface, which correspond to a set of controls for items that are controlled by the apparatus;
a display screen, which indicates the current temperature setting, time and date;
a recessed program and enter button that allows a user to enter temperature settings to a thermostat;
a clear button for deleting any entered information;
an electric cradle that is used to recharge the apparatus;
a (USB) port and a plurality of serial/parallel ports that are used to connect a computerized device to the apparatus;
an RS-232 port to standardize a transmission of serial data between any devices and the apparatus;
a microcontroller for processing information and data;
a serial to parallel converter and a parallel to serial converter; and
a transmitting means for transmitting a signal to and from said controlled remote control apparatus.
